(19) United States
(12) Patent Application Publication
(10) Pub. No.: US 2010/0287779 A1
(43) Pub. Date: Nov. 18, 2010

(54) KNIFE WITH INTERCHANGEABLE PORTION

(76) Inventor: Brady B. Wilson, Heber City, UT (US)

Correspondence Address: Brian J. Riddle;Vancott, Bagley Cornwall & McCarthy, 36 S. State Street, Suite 1900, Salt Lake City, UT, 84111, US

(21) Appl. No.: 12/465,541

(22) Filed: May 13, 2009

(51) Int. Cl. B26B 5/00; B26B 11/00

(52) U.S. Cl. 30/122; 30/144; 7/158; 30/339

(57) ABSTRACT

A knife system may comprise a blade, the blade defining a number of voids, and a number of features configured to be removably coupled to the blade, wherein the blade is configured to house the features in the voids defined by the blade. The feature may be coupled to the blade through any means which will allow it to be easily removed, interchanged, and/or replaced.

### BACKGROUND

In outdoor activities such as camping and wildlife hunting, or other activities such as cooking, home improvement, or construction, a knife is an essential piece of equipment. Different types of blades have been designed to fit specific types of jobs. For example, some knives are better fit for gutting a fish, while other knives may be better for cutting through an animal's bone. Further, some knives are geared more towards combat situations.

A standard knife consists of a point, a sharp edge which runs the length of the blade from the point to the handle, and the handle itself. A fixed blade knife is typically stronger and more durable due to a portion of the blade which extends into the handle and is firmly attached with no moving parts present.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a side view of a fixed blade knife including an interchangeable portion, according to an embodiment of the present exemplary system and method.

FIG. 2 is an illustrative depiction of the interchangeable portion of the fixed blade knife of FIG. 1, according to an embodiment of the present exemplary system and method.

FIG. 3 is an illustrative depiction of the interchangeable portion of the fixed blade knife of FIG. 1 wherein the interchangeable blade is removed, according to an embodiment of the present exemplary system and method.

FIG. 4 is an illustrative depiction of the void in the fixed blade knife, according to an embodiment of the present exemplary system and method.

FIGS. 5A-C are illustrative depictions of three exemplary features for inclusion in a fixed blade knife with an interchangeable portion, according to an embodiment of the present exemplary system and method.

FIG. 6 is an illustrative depiction of the interchangeable portion of a fixed blade knife wherein the interchangeable blade is removed, according to another embodiment of the present exemplary system and method.

FIG. 7 is an illustrative flow diagram describing a process for fabricating a fixed blade knife with an interchangeable portion, according to an embodiment of the present exemplary system and method.

FIG. 8 is an illustrative depiction of a fixed blade knife including a number of interchangeable portions, according to an embodiment of the present exemplary system and method.

Throughout the drawings, identical reference numbers designate similar, but not necessarily identical, elements.

### DETAILED DESCRIPTION

As mentioned above, a knife is an essential piece of equipment for any survival, camping, or hunting scenario. Different types of blades have been designed to meet specific types of cutting jobs. Often times a knife contains serrated portions formed into varying portions of the blade. Often, these serrated portions are formed between the handle and the forward edge of the blade. The location, form, and shape of these serrated portions vary as the cutting jobs they are designed for vary. It can often be a burden to carry several different knives of differing utility in any hunting, camping, or combat scenario.

Some previous solutions to relieving this burden involve carrying a knife which contains several non-fixed blades folded in a housing (e.g. Victorinox's Swiss Army® knife, or a Leatherman® multi-tool), or a knife whose entire cutting portion comprises interchangeable blades. However, these knives, and the blades incorporated therein, lack the strength and durability of a fixed blade knife. A fixed blade knife is stronger due to a portion of the blade referred to as the tang. The tang extends into the handle of the fixed blade knife and is firmly secured. Unlike other types of knives, a fixed blade knife has no moving parts such as hinging or locking mechanisms that may draw away from the strength of the knife. The strength provided by a fixed blade knife is essential in withstanding the stresses and strains of repetitive use placed on a knife.

The present specification relates to a knife with an interchangeable portion positioned at a location between the handle and the point. This interchangeable portion may, for example, be placed where the serrated portion is typically located on a standard fixed knife blade. As used in the present specification and the appended claim, the term “feature” is meant to be understood broadly as any configuration of cutting or non-cutting edges that can be inserted into a fixed blade knife, including, but not limited to, an interchangeable blade or an interchangeable portion of a blade.

Through use of a knife embodying principles described herein, a user may adapt their knife to fit the needs of their present situation without having to carry multiple knives or sacrifice the strength and durability of a fixed blade knife. A user may also be able to replace the interchangeable portion when it becomes worn out without having to sharpen an otherwise difficult portion of the blade to sharpen, or replace the entire knife altogether. Thus, a user may utilize the interchangeable portion (110) of the blade to cut through materials such as bone or steel, which would otherwise destroy or significantly dull the regular cutting edge of the fixed blade knife.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

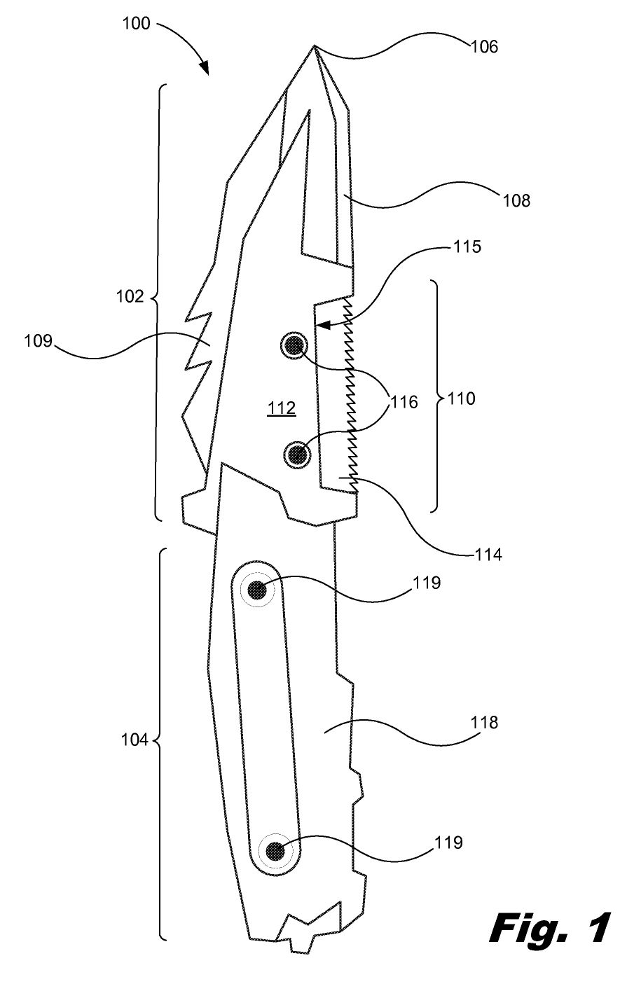

FIG. 1 is an illustrative depiction of a fixed blade knife (100) with an interchangeable portion (110). The knife (100) may include a blade portion (102) and a handle portion (104). The blade portion (102) may include a point (106), which is used for piercing, and a forward edge (108) which is typically used for slicing. The blade portion (102) may also include additional features. In one exemplary embodiment, the spine of the blade portion (102) may be shaped to serve a practical purpose or for aesthetic appeal. For example, the spine of the blade portion (102) may include a gut hook (109) which is used to hook under and cut materials. A gut hook (109) may assist a user in skinning and/or gutting animals, for example. The gut hook (109) may also be used as a line cutter, as it hooks into the line and traps it while it cuts. Other auxiliary features such as swage portions, tanto points, etc. may also be incorporated into the blade portion (102) of the knife (100).

The handle portion (104) may include a grip (118). The grip (118) is used to provide a means for a user of the knife (100) to grasp the knife without having to grip the bare tang (not shown) of the knife (100). As discussed above, the tang of the knife (100) extends into the handle portion (104) of the knife (100). The grip (108) may be coupled to the tang of the knife (100) via a number of fasteners (119) such as rivets, screws, bolts, pins etc. The handle portion (104) may further include additional auxiliary features including front and/or rear quillon portions, finger groves, finger rings, etc.

An interchangeable portion (110) may be positioned between the forward edge (108) and the handle (104) of the knife (100). The interchangeable portion (110) may be positioned either on the spine or cutting edge of the knife (100). In one embodiment, the interchangeable portion (110) is positioned where a serrated portion of a knife may typically be located. The interchangeable portion (110) may include a void (115) defined in the blade material (112) of the knife (100) wherein a feature such as an interchangeable blade (114) may be inserted. In one embodiment, the interchangeable blade (114) may be fastened to the blade material (112) via a bolt or screw system (116). Other fasteners such as rivets or pins may also be used to secure the interchangeable blade (114) within the void (115).

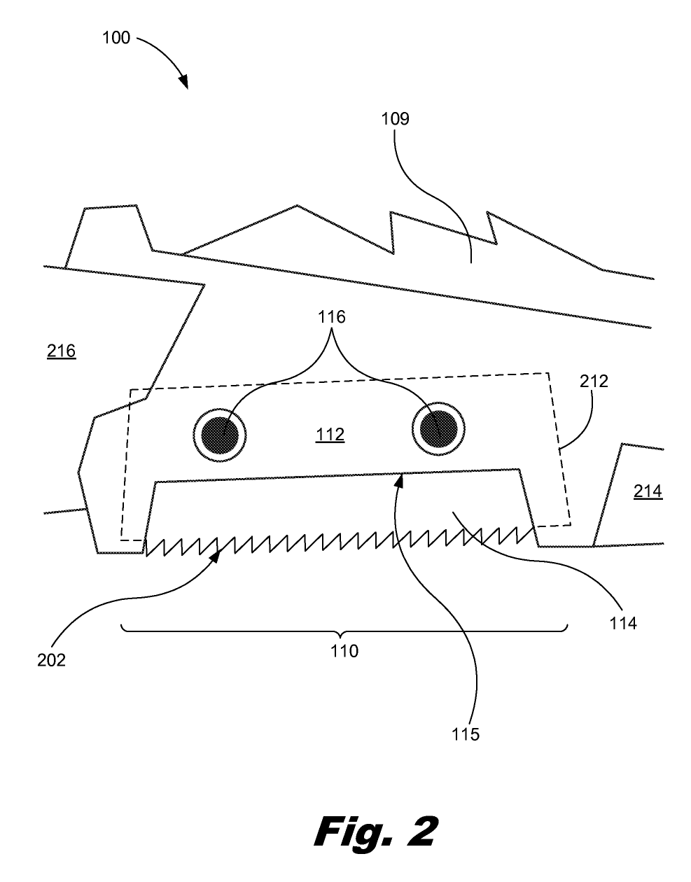

FIG. 2 is an illustrative depiction of a closer view of the interchangeable portion (110) of a fixed blade knife (100). The left side of the figure is where the tang of the knife (100) extends to the handle (216). The right side of the figure is where the knife extends to the forward edge and point (214). The interchangeable blade (114) containing a serrated edge (202) is inserted into the void (115) in the blade material (112). Again, the interchangeable blade (114) may be fastened to the blade material (112) by, for example, a screw or bolt system (116). The dotted line (212) represents the outline of the interchangeable blade (206) as it is inside the void (115) formed in the blade material (112), according to an embodiment of the present exemplary system and method.

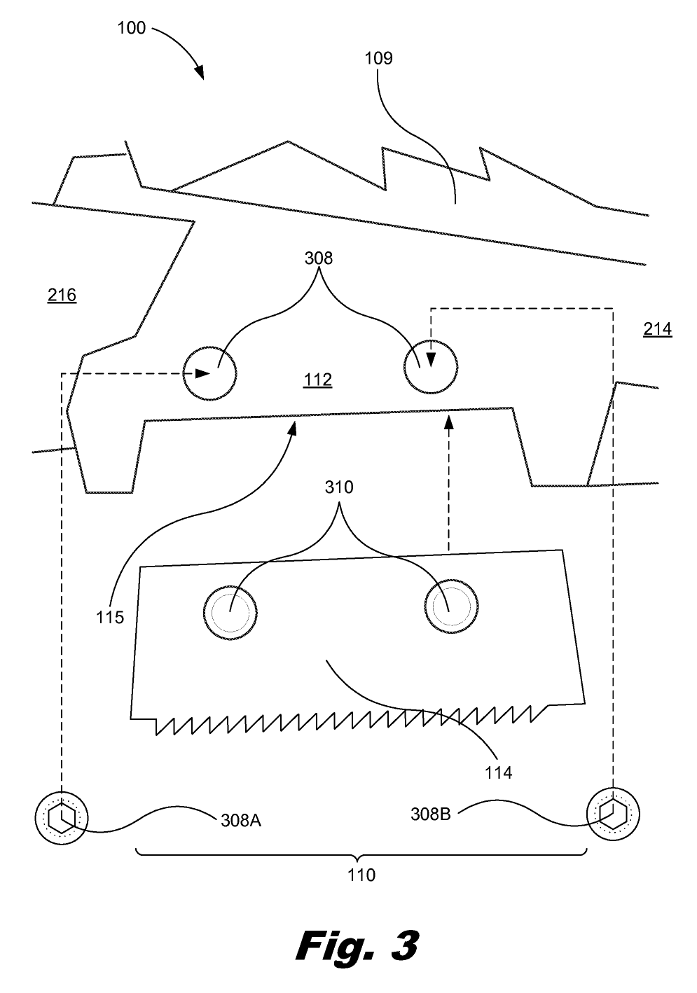

FIG. 3 is an illustrative depiction of the interchangeable portion (110) of a fixed blade knife (100) removed from the fixed blade knife (100). Like in FIG. 2, the left side extends toward the handle (216) and the right side extends toward the forward edge and point (214). This figure shows the interchangeable blade (114) removed from the void (115) in the blade material (112). A number of holes (308) are formed in the blade material (112) and are spaced far enough apart so that when the interchangeable blade (114) is inserted into the void (115) and secured with the screws (308A and 308B), for example, the interchangeable blade (114) will be firmly fastened to the blade material (112). Further, the holes (310) formed in the interchangeable blade (114) are configured to match the holes (308) formed in the blade material (112) of the fixed blade knife (100). As depicted in the various figures, two holes (308) may be formed in the blade material (112). However, any number of holes may be formed in the blade material (112), and corresponding holes (310) may be formed in the interchangeable blade (114).

The screws (308A and 308B) are configured to thread into both the holes (310) formed in the interchangeable blade (114) and the holes (308) formed in the blade material (112). In one exemplary embodiment, the screws (308A and 308B) may be hex-head screws. Also, the screws may be made of any material that is sufficiently strong enough to secure the interchangeable blade (114) within the void (115). In one exemplary embodiment, the screws may be made of stainless steel.

Once the interchangeable blade (114) is inserted into the void (115) of the fixed blade knife (100), the screws (308A and 308B) may then be securely threaded into the holes (308) formed in the blade material (112), through the holes (310) formed in the interchangeable blade (114), and again into the back side (not shown) of the blade material (112) of the fixed blade knife (100). The holes (308) formed in the blade material (112) may be formed through the entire thickness of the blade material (112), or may be formed such that the screws (308A and 308B) do not protrude out the back (not shown) of the blade material (112), but still thread into the back of the blade material.

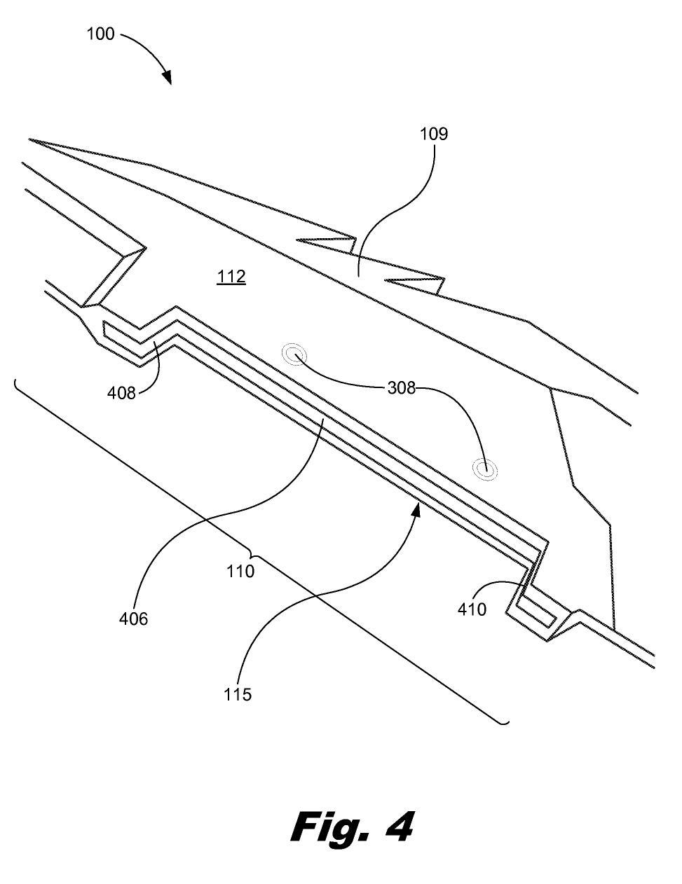

FIG. 4 is an illustrative depiction of the void (115) formed in a fixed blade knife (100) in which the interchangeable blade (FIG. 3, 114) is inserted. The figure shows the knife (100) at an angle for a better view of the void (115). As depicted in FIG. 4, the void (115) further comprises a slot (406) in which the interchangeable blade is inserted. The two holes (308) in the blade material (112) are empty so as to allow a blade to be inserted into the slot (406). The interchangeable blade (114, FIG. 3) may then be secured with, for example, a screw or bolt system once it has been inserted to its proper position. The slot (406) consists of a forward guide portion (408) and a back guide portion (410) which help guide the interchangeable blade (FIG. 4, 114) in and out of the slot (406).

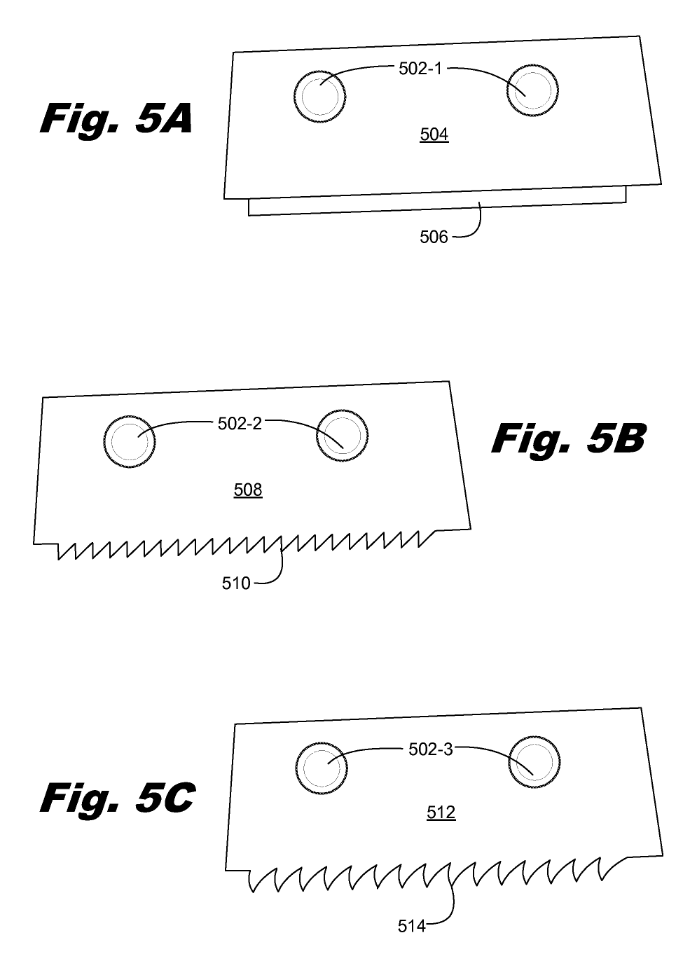

FIGS. 5A through 5C are illustrative depictions of three exemplary features (504, 508, 512) for inclusion in a fixed blade knife with an interchangeable portion. The types of features may include interchangeable blades (504, 508, 512), and are not limited to the ones shown in FIGS. 5A through 5C. The interchangeable blades (504, 508, 512) shown are mere examples or possibilities of the types of blades that could be used.

The top interchangeable blade (504) includes a razor edge (506). The middle interchangeable blade (508) includes a straight serrated edge (510). The bottom interchangeable blade (512) includes a more coarsely serrated edge than the middle interchangeable blade (508). Interchangeable blade (512) also has more curvy serrations. Each interchangeable blade (504, 508, 512) consists of a pair of holes (502-1, 502-2, 502-3) for securing the interchangeable blade (504, 508, 512) to the blade material (FIG. 3, 112) of the fixed blade knife (FIG. 1, 100). As mentioned above, the interchangeable blade (504, 508, 512) may include any type of cutting edge as may be readily known by those skilled in the art.

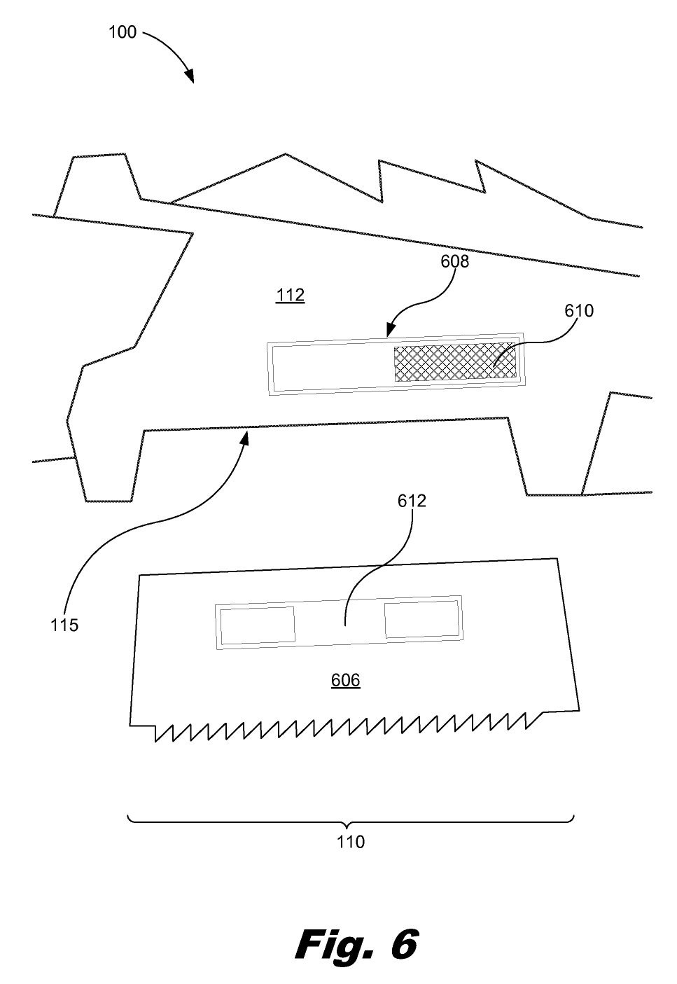

FIG. 6 is an illustrative depiction of an interchangeable blade (606) of a fixed blade knife (100) removed from the fixed blade knife (100). In one embodiment, the mechanism by which the interchangeable blade (606) is secured to the blade material (112) could be a slide and lock mechanism (608) as depicted in this figure. In this embodiment, the blade material (112) may include a slide and lock mechanism (608) wherein the user slides a sliding element (610) to lock the interchangeable blade (606) into place once it has been inserted into the void (115). The interchangeable blade (606) may include a corresponding mating portion (612) designed to be clamped to or locked by the slide and lock mechanism (608) embedded in the blade material (112).

The present specification describes only a few methods by which the interchangeable blades (114, 504, 508, 512, 606) may be coupled or fastened to the blade material (112) once they have been inserted into the void (115). However, any method which will securely fasten the interchangeable blade (114, 504, 508, 512, 606) to the blade material (112) may be used.

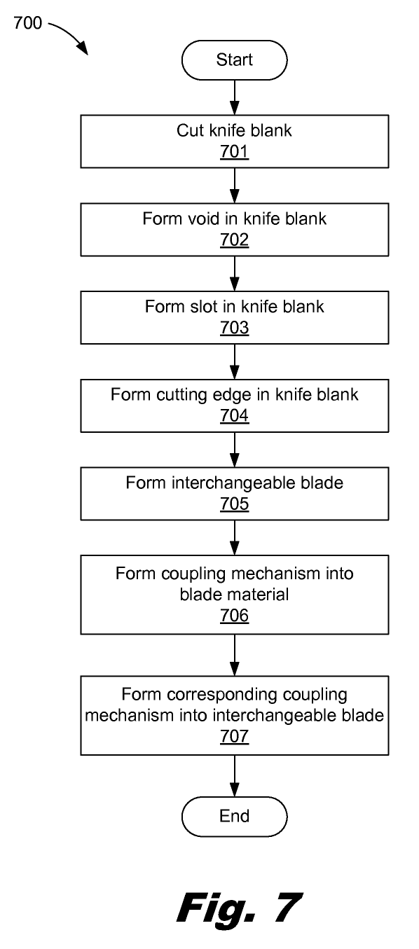

FIG. 7 is an illustrative flow diagram (700) describing a process for fabricating a fixed blade knife (FIG. 1, 100) with an interchangeable portion (FIG. 3, 110). The following process is just one example of how a knife (FIG. 1, 100) with an interchangeable portion (FIG. 1, 110) may be fabricated; any appropriate method may be used. Further, the following steps may be performed in a different order, or certain steps may be excluded from the overall process.

First, a knife blank may be cut from a piece of metal. (step 701). The metal may be any metal strong or hardened enough to hold a sharpened cutting edge. In one specific example, the metal may be 440C stainless steel. The process selected to cut the knife blank may include the use of any known cutting mechanism including, but not exhaustive of, a vertical mill, a water jet, a laser, etc. In one specific example, the cutting mechanism employed may be selected such that the knife blank is not subjected to too much heat, as this may cause the material (metal) to harden, weaken, or otherwise degrade.

Next, the interchangeable portion (FIG. 1, 110) may be formed in the knife blank. As described above, this may include the formation of the void (FIG. 1, 115) and the slot (FIG. 4, 406) (including a forward portion (FIG. 4, 408) and/or a back portion (FIG. 4, 410)). In one exemplary embodiment, the void (FIG. 1, 115) may be cut from a portion of the knife blank perpendicular to the cutting edge of the blade (step 702). In one specific embodiment, the void (FIG. 1, 115) may be cut from the portion of the knife blank where serrations are normally located, and, more specifically, between the heel of the blade and the forward edge of the blade. The void (FIG. 1, 115) may be formed by making a cut into the knife blank ⅜ inches deep, perpendicular to the cutting edge of the blade portion (FIG. 1, 102) of the fixed blade knife (FIG. 1, 100), and 2.25 inches long, parallel to the cutting edge of the blade portion (FIG. 1, 102). However, it will be understood that the dimensions of the void (FIG. 1, 115) may vary depending on the desired size of the interchangeable portion (FIG. 1, 110), the desired style of the interchangeable portion (FIG. 1, 110), the size of the interchangeable blade (FIG. 1, 114) to be inserted into the void (FIG. 1, 115), the length of the fixed blade knife (FIG. 1, 100), etc.

Next, the slot (FIG. 4, 406) (including a forward portion (FIG. 4, 408) and/or a back portion (FIG. 4, 410)) may be formed (step 703) by making a cut in the void (FIG. 1, 115) parallel to the cutting edge of the blade portion (FIG. 1, 102) of the fixed blade knife (FIG. 1, 100). The slot (FIG. 4, 406) may be formed in the center of the thickness of the blade portion (FIG. 1, 102) along the length of the void (FIG. 1, 115). The thickness and depth of the slot (FIG. 4, 406) (including a forward portion (FIG. 4, 408) and/or a back portion (FIG. 4, 410)) may vary depending on the thickness and size of the interchangeable blades (FIG. 1, 114) which will be inserted into the void (FIG. 1, 115), and/or the thickness of the knife blank. In one specific embodiment, the knife blank may be ¼ inches thick. In this embodiment, the slot (FIG. 4, 406) (including a forward portion (FIG. 4, 408) and/or a back portion (FIG. 4, 410)) may be formed by cutting a 1/16 inch wide slot in the center of the knife blank. The 1/16 inch slot (FIG. 4, 406) may be formed via the use of a 1/16 inch slot cutter on a vertical mill, or via a 1/16 inch grinding disc.

It will be understood that the dimensions of the interchangeable portion (110) of the fixed blade knife (FIG. 1, 100), including the void (FIG. 3, 115) and the slot (FIG. 4, 406) (including a forward portion (FIG. 4, 408) and/or a back portion (FIG. 4, 410)), may vary depending on the desired size of the interchangeable portion (Fig, 1, 110), the desired style of the interchangeable portion (FIG. 1, 110), the size of the interchangeable blade (FIG. 1, 114) to be inserted into the void (FIG. 1, 115), the length of the fixed blade knife (FIG. 1, 100), etc. Further, as explained above, the interchangeable portion (FIG. 1, 110) may be located anywhere on the blade portion (FIG. 1, 102) of the fixed blade knife (FIG. 1, 100).

After a knife blank has been formed (step 701) and the interchangeable portion (110) has been formed in the knife blank (step 702), the angles in the blade portion (FIG. 1, 102) that form the cutting edge or edges of the blade portion (FIG. 1, 102) may be machined (step 704). The process of machining the cutting edge of the blade portion (FIG. 1, 102) may include the use of a milling machine, or may be formed by sanding, grinding, etc. In one specific example, a vertical mill may be used to form the cutting edge of the blade portion (FIG. 1, 102).

Once the interchangeable portion (110) has been formed, an interchangeable blade (FIG. 1, 114) may be cut to fit the void (FIG. 1, 115) created in the fixed blade knife (FIG. 1, 100) (step 705). The interchangeable blade (FIG. 1, 114) may either be manufactured specifically for this purpose or cut from an already existing blade such as a sawzall-type blade or a band saw type blade. The interchangeable blade (FIG. 1, 114) may have any type of serration or cutting edge to fit any type of cutting job.

Next, a coupling mechanism is incorporated into the interchangeable portion (FIG. 1, 110) of the fixed blade knife (FIG. 1, 100) (step 706). In one exemplary embodiment, holes (FIG. 3, 308) are drilled into the blade material (FIG. 1, 112) above the void (FIG. 1, 115) (step 706) so as to allow a screw or bolt system to be employed to secure the interchangeable blades (FIG. 1, 114) which are to be inserted into the void (FIG. 3, 115). As described above, the holes (FIG. 3, 308) may be drilled all the way through the blade material (FIG. 1, 112) and may then be threaded to facilitate screws or bolts, or the holes (FIG. 3, 308) may be drilled through a portion of the blade material (FIG. 1, 112) such that the screws (FIG. 3, 308A, 308B) do not protrude out the back (not shown) of the blade material (FIG. 1, 112), but still thread into the back of the blade material (FIG. 1, 112). In another exemplary embodiment, a slide and lock mechanism (FIG. 6, 608) may be incorporated into the blade material (FIG. 1, 112) as described above in connection with the exemplary embodiment of FIG. 6.

Finally, corresponding coupling mechanisms may be formed in the interchangeable blade (step 708). In one embodiment, after the holes (FIG. 3, 308) have been drilled into the blade material (FIG. 1, 112), corresponding holes (FIG. 3, 310) are then drilled in the interchangeable blade (step 708) that will match the spacing of the holes (FIG. 3, 308) drilled in the blade material (FIG. 1, 112) of the fixed blade knife (FIG. 1, 100). This will allow the interchangeable blade (FIG. 1, 114) to be inserted to a proper position and held securely in place through the use of bolts or screws (FIG. 3, 308A, 308B). In the exemplary embodiment of FIG. 6, a corresponding mating portion (FIG. 6, 612) may be formed in the interchangeable blade (FIG. 6, 606).

### Alternative Embodiments

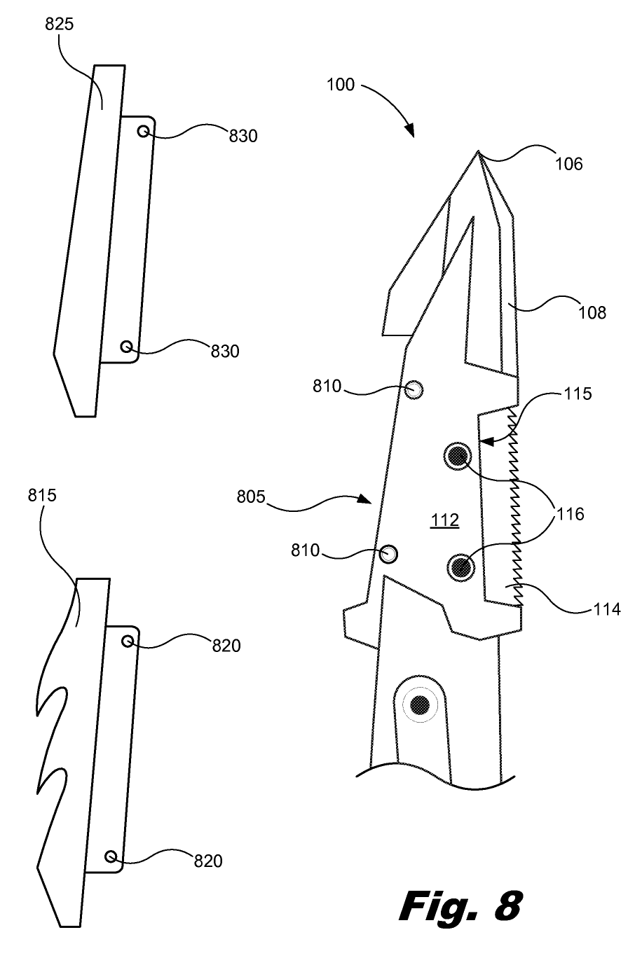

FIG. 8 is an illustrative depiction of a fixed blade knife including a number of interchangeable portions, according to an embodiment of the present exemplary system and method. In this exemplary embodiment, the fixed blade knife (100) may include a number of voids (115, 805) that are configured to accommodate a number of interchangeable blades or features. As used in the present specification and the appended claim, the term “feature” is meant to be understood broadly as any configuration of cutting or non-cutting edges that can be inserted into a void (115, 805) of a fixed blade knife (100). For example, such a feature may include the interchangeable blade (114) of FIG. 8 and previous figures as described above.

Further, in one exemplary embodiment, the feature may include a gut hook feature (815) or a smooth edge feature (825). The features (815, 825) may include holes (820, 830) that are configured to match holes (810) within the blade material (112). As discussed above, in connection with other exemplary embodiments, the features (815, 825) may be coupled to the blade material (112) via any fasteners such as rivets, screws, bolts, pins etc. In one exemplary embodiment, for example, the holes (810) within the blade material (112)

Additionally, a feature (815, 825) may include any cutting or non-cutting edge. For example, feature (825) may include a smooth surface configured to form the smooth surface of the spine of the fixed blade knife (100). Alternatively, feature (815) may include a gut hook. Still further, the feature (815, 825) may include any edge used to increase the utility or aesthetics of the fixed blade knife (100) including, but not limited to, a serrated, a razor edge, a saw edge, a fish scaling edge, a file edge, an edge with pictorial engravings thereon, etc.

In sum, a fixed blade knife (FIG. 1, 100) is created with a number of interchangeable portions (FIG. 1, 110) where the serrations in a blade are typically located, between the heel and forward edge of the fixed blade knife (FIG. 1, 100), or any other area of the knife blade. An interchangeable blade (FIG. 1, 114) may be configured to fit into the void (FIG. 1, 115) of the interchangeable portion (FIG. 1, 110). The interchangeable blade (FIG. 1, 114) may be replaced with different types of serrated blades suited for different cutting jobs. The interchangeable (FIG. 1, 114) blade may also be replaced if it becomes worn out.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A knife comprising:
a blade, the blade defining a number of voids,
wherein the blade is configured to house a number of features in the voids defined by the blade.

2. The knife of claim 1, wherein the features are removably coupled to the blade.

3. The knife of claim 2, wherein the features are removably coupled to the blade via a screw or bolt system.

4. The knife of claim 2, wherein the features are removably coupled to the blade via a locking or clamping mechanism formed in the blade.

5. The knife of claim 1, wherein a number of the features is a saw blade.

6. The knife of claim 1, wherein a number of the features includes a serrated edge.

7. The knife of claim 1, wherein a number of the features includes a razor edge.

8. The knife of claim 1, wherein the blade comprises 440C stainless steel.

9. A method of manufacturing a knife, comprising:
forming a blade, and
forming a number of void portions in the blade,
wherein the void portions are configured to house a feature.

10. The method of claim 9, further comprising:
forming a coupling mechanism between the blade and the features,
wherein the coupling mechanism is configured to removably couple the features within the void portions.

11. The method of claim 10, wherein the coupling mechanism is a coupling mechanism selected from the group consisting of a screw system, a bolt system, and a slide and lock system.

12. The method of claim 9, further comprising forming a number of slot portions in the void portions of the blade parallel to the cutting edge of blade, wherein the slot portions are configured to retain the features in the blade.

13. The method of claim 12, wherein the step of forming a coupling mechanism between the blade and the features comprises:
forming a number of threaded holes in a portion of the blade, wherein the threaded holes are formed perpendicularly through the slot portions;
forming a number of holes in the features, wherein the holes formed in the features are configured to match the threaded holes formed in the blade; and
forming a number of screws, wherein the screws are configured to be threaded into the threaded holes of the blade, and through the holes of the features.

14. The method of claim 12, wherein the step of forming a coupling mechanism between the blade and the features comprises:
forming a number of slide and lock systems in the blade, wherein the slide and lock systems are formed perpendicularly through the slot portions; and
forming a number of mating portions in the features, wherein the mating portions formed in the features are configured to mate with the slide and lock systems formed in the blade.

15. A knife system comprising:
a blade, the blade defining a number of voids; and
a number of features configured to be removably coupled to the blade;
wherein the blade is configured to house the features in the voids defined by the blade.

16. The knife system of claim 15, further comprising:
a first coupling mechanism formed in the blade; and
a second coupling mechanism formed in the features configured to mate with the first coupling mechanism formed in the blade.

17. The knife system of claim 16, further comprising a number of slot portions defined in the void portions defined in the blade parallel to the cutting edge of blade, wherein the blade is configured to retain the features in the slot portions.

18. The knife system of claim 17, further comprising a third coupling mechanism,
wherein the first coupling mechanism formed in the blade comprises a number of threaded holes defined in a portion of the blade, wherein the threaded holes are formed perpendicularly through the slot portions of the blade;
wherein the second coupling mechanism formed in the features comprises a number of holes defined in the features, wherein the holes defined in the features are configured to match the threaded holes defined in the blade; and
wherein the third coupling mechanism comprises a number of screws, wherein the screws are configured to be threaded into the threaded holes defined in the blade, and through the holes defined in the features.

19. The knife system of claim 16, wherein the first coupling mechanism formed in the blade comprises a number of slide and lock systems in the blade, wherein the slide and lock systems are formed perpendicularly through the slot portions, and
wherein the second coupling mechanism formed in the feature comprises a number of mating portions defined in the features, wherein the mating portions defined in the features are configured to mate with the slide and lock systems formed in the blade.

20. The knife system of claim 18, wherein the threaded holes defined in a portion of the blade are configured to be defined through a portion of the blade.
